(19) United States
(12) Patent Application Publication
(10) Pub. No.: US 2026/0164253 A1
(43) Pub. Date: Jun. 11, 2026

(54) WIRELESS NETWORK CELL AUDIT TOOLS

(71) Applicant: T-Mobile Innovations LLC, Overland Park, KS (US)

(72) Inventors: Jamir A. Dirksen, Casselberry, FL (US); Justin L. Farmer, Raleigh, NC (US); Dat Ho, Orlando, FL (US); Miguel Villavicencio, Ocoee, FL (US)

(21) Appl. No.: 18/977,810

(22) Filed: Dec. 11, 2024

(51) Int. Cl. H04W 16/18; H04W 76/14

(52) U.S. Cl. CPC H04W 16/18; H04W 76/14

(57) ABSTRACT

A method of maintaining a cell site. The method comprises accessing an inventory of radio access network (RAN) equipment by an application; analyzing properties of equipment at the cell site by the application; looking up a password associated with the cell site by the application; establishing a secure shell session to the cell site by the application based on the password; accessing current information about the equipment of a cell located at the cell site via the secure shell session by the application; and determining by the application that a connection of a communication link between a first equipment cabinet associated with the cell and located at the cell site and a second equipment cabinet associated with the cell and located at the cell site is loose.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Communication network operators build systems and tools to monitor their networks, to identify network elements (NE) that need maintenance, to assign maintenance tasks to personnel, and to fix network elements. Operational support systems (OSSs) may be provided by vendors of NEs to monitor and maintain their products. When trouble occurs in NEs, the OSS and/or the NEs may generate an alarm notification. An incident reporting system may be provided by the network operator to track incident reports which may be assigned to employees to resolve one or more pending alarms. A network operation center (NOC) may provide a variety of workstations and tools for NOC personnel to monitor alarms, close incident reports, and maintain the network as a whole. It is understood that operating and maintaining a nationwide communication network comprising tens of thousands of cell sites and other NEs is very complicated.

### SUMMARY

In an embodiment, a method of maintaining a cell site is disclosed. The method comprises accessing an inventory of radio access network (RAN) equipment by an application executing on a computer system, wherein the inventory of RAN equipment identifies a plurality of equipment at the cell site and properties of the plurality of equipment at the cell site; analyzing the properties of the plurality of equipment at the cell site by the application; and based on the analyzing, looking up a password associated with the cell site by the application. The method further comprises establishing a secure shell session to the cell site by the application based on the password; accessing current information about the equipment of a cell located at the cell site via the secure shell session by the application; and determining by the application that a connection of a communication link between a first equipment cabinet associated with the cell and located at the cell site and a second equipment cabinet associated with the cell and located at the cell site is loose.

In another embodiment, a method of maintaining a cell site is disclosed. The method comprises connecting to an operational support system (OSS) associated with the cell site by an application executing on a computer system; establishing a secure shell session by the application with the cell site via the OSS; and determining a configuration of equipment associated with a cell at the cell site by the application reading information via the secure shell session from the cell site. The method further comprises, based on the configuration of equipment associated with the cell, determining which of a plurality of configuration scenarios fits the cell and accessing an inventory of radio access network (RAN) equipment by the application, wherein the inventory of RAN equipment identifies a plurality of equipment at the cell site and properties of the plurality of equipment at the cell site. The method further comprises, based on the configuration scenario that fits the cell, determining a correct fiber optic configuration between a cell site equipment rack and a radio head at the cell site by the application; comparing the correct fiber optic configuration to an actual fiber optic configuration between the cell site equipment rack and the radio head of the cell site by the application, wherein the actual fiber optic configuration is determined based on the inventory of RAN equipment; and indicating by the application a mismatch between the actual fiber optic configuration and the correct fiber optic configuration.

In yet another embodiment, a cell site maintenance system is disclosed. The system comprises an at least one processor; a non-transitory memory, and an application stored in the non-transitory memory. When executed by the at least one processor, the application receives an activation input from a user of a network operation center (NOC), accesses inventory of radio access network (RAN) equipment, wherein the inventory or RAN equipment identifies a plurality of equipment at each of a plurality of cell sites, establishes a secure shell session to a cell site, and accesses information about equipment at the cell site. The application when executed by the at least one processor also, based on accessing the inventory and on accessing information about equipment at the cell site, tests if a connection of a communication link between a first equipment cabinet and a second equipment cabinet at the cell site is loose, based on accessing the inventory and on accessing information about equipment at the cell site, tests if a fiber optic link between an equipment rack at the cell site and a radio head of the cell site is cross-connected, if the connection between the connection is loose, notifies a technician located at the cell site to tighten the connection, and if the fiber optic link is cross-connected, notifies a technician located at the cell site to reconnect the fiber optic link.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a system according to an embodiment of the disclosure.

FIG. 2 is an illustration of a corrective action at a cell site according to an embodiment of the disclosure.

FIG. 3 is an illustration of a communication connection between equipment cabinets at a cell site according to an embodiment of the disclosure.

FIG. 4 is a flow chart of a method according to an embodiment of the disclosure.

FIG. 5 is a flow chart of another method according to an embodiment of the disclosure.

FIG. 6A and FIG. 6B is a block diagram of a communication network according to an embodiment of the disclosure.

FIG. 7 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Wireless network cell equipment audit tools are described herein. For some particular equipment problems at a cell site, remote diagnosis using ordinary network management system (NMS) tools is challenging. For example, a user may not know a sequence of steps to follow to identify the presence of a given fault. The user may not have authority in a given execution context to access tools with which to identify the presence of a given fault. The user, in a previous system, might have needed to complete a diagnosis and corrective action using multiple different tools and/or workstations in what can be referred to as a “swivel seat” procedure that is prone to error and time consuming. The current disclosure teaches two related but distinct cell audit tools and a system that automatically executes the tools prior to a field technician leaving a cell site during a maintenance activity, whereby to prompt the field technician to take corrective action when still located at the cell site.

In some circumstances, equipment located at a cell site includes a communication link between two different equipment cabinets. This communication link includes a first cable connector connecting a first equipment cabinet to the cable and a second cable connector connecting a second equipment cabinet to the cable. If either cable connector is loose, the two equipment cabinets may not communicate with each other and wireless communication supported by the effected cell can be degraded. Alarms presented at an NMS interface may indicate degraded cell performance but not identify the loose cable connector as the root cause. The diagnostic tool will access an inventory or list of cell equipment, validate that the given user has authorization to execute the diagnostic command on that cell, look up a password, log into an appropriate operational support system (OSS) associated with the cell equipment using the looked-up password, establish a secure shell (SSH) session between the OSS and the cell, access current information of the cell equipment, and determine whether the cable connector is loose. If the cable connector is loose, the maintenance action is to tighten the cable by a field technician. In an embodiment, on the event of a field technician preparing to leave a cell site, the cable link diagnostic test can be automatically run and if the test indicates a loose connection, the field technician can be hailed and instructed to tighten the loose connection while still on-site and before leaving the cell site, thereby avoiding a separate truck roll to resolve the problem.

In some circumstances, equipment located at a cell site involves cell equipment in an equipment cabinet at the base of the cell site having fiber optic cables that are cross-connected to a radio head at the cell site (e.g., a radio head mounted at the top of a cell tower or mast or other elevated structure). The cross-connection of fiber optic cables can be a simple error incurred during initial build-out of the cell site. The affected cell may still function but in a low-performance mode of operation. It is also possible that the cross-connection of fiber optic cables may occur during the course of on-site maintenance by a field technician. Alarms presented by an NMS interface may indicate degraded cell performance but not identity the fiber optic cable cross-connection as the root cause. The diagnostic tool will access the inventory or list of cell equipment, validate that the given user has authorization to execute the diagnostic command on that cell, look up a password, log into an appropriate OSS associated with the cell equipment using the looked-up password, establish an SSH session between the OSS and the cell, access current information of the cell equipment, determine the actual fiber optic cable connections configuration at the cell, determine a connection scenario that is applicable to the particular cell by looking up in the inventory, determine a design configuration of the fiber optic cable connections based on the applicable connection scenario, and determine whether the fiber optic cables are cross-connected by comparing the actual fiber optic cable connection configuration to the design configuration. This process can involve determining if the given cable connection configuration is associated to an antenna sector that is an α-sector (alpha-sector), a β-sector (beta-sector), or a γ-sector (gamma-sector) of the cell radio head. This process can involve determining the IP addresses of the radio head sectors. From this analysis, it can be determined if the cable connection configuration is correct or if the fiber optic cable connections are cross-connected. In brief, in an embodiment, the process involves looking-up key characteristics or properties; based on the looked-up characteristics, select an appropriate configuration or scenario that applies; and based on the appropriate configuration, execute an audit test.

If the fiber optic cables are cross-connected, the maintenance action is to disconnect the cross-connected fiber optic cables where they connect to the cell equipment at the base of the cell site and reconnect the fiber optic cables to the correct connectors at the base of the cell site by the field technician. In an embodiment, in the event of a field technician preparing to leave a cell site, the fiber optic cable cross-connection diagnostic test can be automatically run and if the test indicates cross-connected fiber optic cables, the field technician can be hailed and instructed to correct the fiber optic cross-connection situation while still on-site and before leaving the cell site, thereby avoiding a separate truck roll to resolve the problem.

The cell audit tools described herein provide a particular technical solution to the technical problem of maintaining complicated and expensive wireless cells in a radio access network. These cell problems are difficult and complicated to analyze properly. Combining both automation that runs these tools correctly and timely with automation that triggers execution of the tools before a field technician leaves a cell site improves the quality of wireless communication service that a wireless communication service provider offers to subscribers, reduces operating expenses of the service provider, and reduces CO2 emissions by reducing truck rolls of field technicians to cell sites to correct these problems.

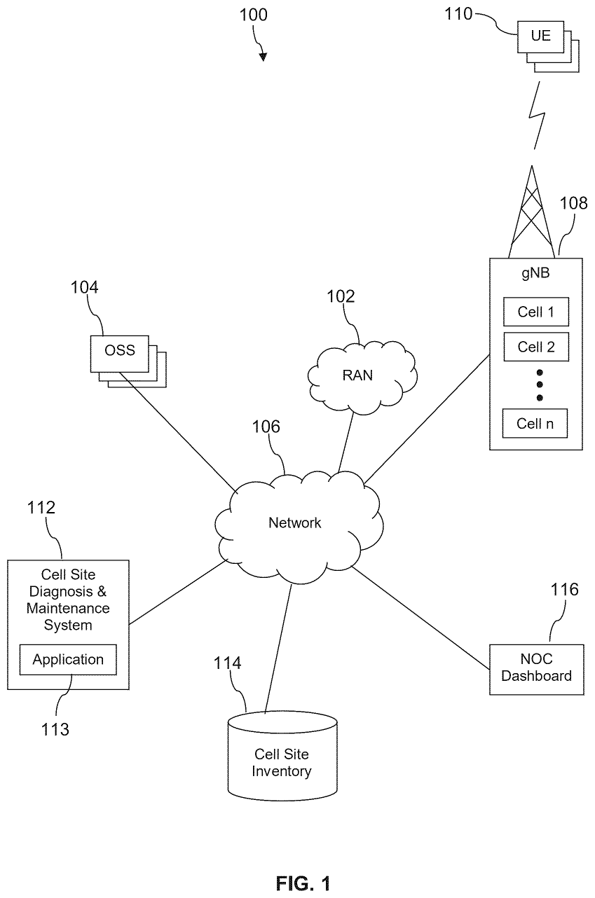

Turning now to FIG. 1, a system 100 is described. In an embodiment, the system 100 comprises a radio access network (RAN) 102, one or more operational support systems (OSSs) 104, a network 106, and a plurality of cell sites 108 that provide wireless access to the radio access network 102 to a plurality of user equipments (UEs) 110. The cell sites 108 may be considered to be part of the RAN 102 but are shown separately in FIG. 1 to promote better understanding of cell sites. It is understood that the system 100 may comprise any number of cell sites 108 and any number of UEs 110. In an embodiment, the system 100 may comprise tens of thousands or even hundreds of thousands of cell sites 108 and tens of millions or even hundreds of millions of UEs 110. The UEs 110 may comprise any mix of cell phones, personal digital assistants, mobile phones, smart phones, wearable computers, headset computers, laptop computers, notebook computers, tablet computers, and Internet of Things (IoT) devices. The network 106 may comprise one or more private networks, one or more public networks, or a combination thereof.

The cell sites 108 may comprise a single cell or a plurality of different cells. For example, a first cell site 108 may comprise only a single cell while a second cell site 108 may comprise two different cells, three different cells, four different cells, five different cells, six different cells, seven different cells, eight different cells, nine different cells, ten different cells, twelve different cells, fifteen different cells, twenty different cells, twenty-five different cells, or some other number of different cells less than fifty different cells. Different cells at the same cell site 108 may provide wireless links to UEs 110 in the same technology but in different frequency bands. Different cells at the same cell site 108 may provide wireless links to the UEs 110 in different technologies and in different frequency bands. Cells may provide wireless links to UEs 110 according to a 6G, a 5G, a long-term evolution (LTE), a code division multiple access (CDMA), a universal mobile communication system (UMTS), or a global system for mobile communication (GSM) telecommunication protocol. Different telecommunication protocols may be referred to as different technologies. For example, a cell providing wireless communication links according to the 5G protocol may be said to support a different technology from a cell providing wireless communication links according to LTE.

The OSSs 104 may be provided by cell site equipment vendors for use by a wireless communication service provider to monitor, manage, and maintain cell site equipment sold to the service provider by the given vendor. An OSS 104 may support personnel of the service provider to retrieve active alarms for conditions on cells and cell sites 108. An OSS 104 may support personnel of the service provider to configure and reconfigure operational parameters of cells and cell sites 108, for example adjusting tilt angles of antennas, adjusting transmit power levels of radio frequency (RF) amplifiers, and other operational parameters. An OSS 104 may support personnel of the service provider to reset equipment items at a cell site 108, to deactivate a cell site 108, or to reactivate a cell site 108. The OSSs 104 are communicatively coupled to the network 106.

In an embodiment, the system 100 comprises a cell site diagnosis and maintenance system 112 that comprises a cell site diagnosis and maintenance application 113 that executes on a computer system. Computer systems are described further hereinafter. The cell site diagnosis and maintenance system 112 is communicatively coupled to the network 106. The system 100 may comprise a cell site inventory 114 that is a data store associated with or provided by a computer system that lists all cell site equipment disposed at the cell sites 108 of the RAN 102 and possibly other support equipment that is not formally considered cell site equipment. The cell site inventory 114 is communicatively coupled to the network 106. The cell site inventory 114 can identify and specify capabilities and/or model and revisions associated with the subject equipment items. The cell site inventory 114 may store RAN equipment data for each of the cell sites 108 and other RAN equipment. The inventory information may include location data describing a location of each cell site 108. The inventory information may identify radio equipment data describing the different radio equipment and corresponding functionalities at each cell site 108, identify antenna elements and antenna sectors associated with cells at each cell site 108, identify power equipment data describing the power equipment and capabilities at each cell site 108 (e.g., rectifiers, wires, power distribution panels), backup power equipment (batteries, gas/diesel/natural gas generators, etc.), identify circuit cards associated with cells of each cell site 108, identify locations of circuit cards within equipment cabinets and cell sites 108, and other like information.

The system 100 may comprise a network operation center (NOC) dashboard 116 or some other network management system (NMS). The NOC dashboard 116 provides access of personnel of the service provider operating the RAN 102 to the OSSs 104, to the cell site diagnosis and maintenance system 112, and to the cell site inventory 114, as well as to other facilities and data stores. The NOC dashboard 116 executes on a computer system and is communicatively coupled to the network 106. It is understood that the OSSs 104, the cell site diagnosis and maintenance system 112, the cell site inventory 114, and the NOC dashboard 116 may intercommunicate with each other and with the RAN 102 and cell sites 108 via their communication links to the network 106.

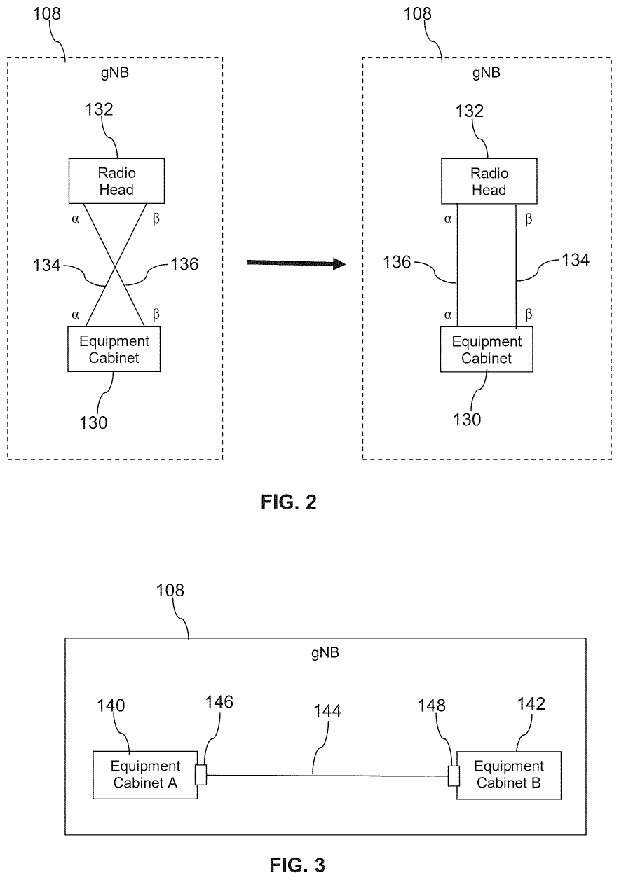

Turning now to FIG. 2, further details of a cell site 108 are described. In an embodiment, an equipment cabinet 130 located inside an equipment shed or equipment building on the ground at a location of the cell site 108 may be communicatively coupled to the equipment of a radio head 132 located at the cell site 108, for example surmounting a mast structure at the cell site 108. For example, a first fiber optic cable 134 may connect the equipment cabinet 130 to the radio head 132 and a second fiber optic cable 136 may connect the equipment cabinet 130 to the radio head 132. In an embodiment, a first equipment cabinet connection α is desirably communicatively coupled to a first radio head connection α by the first fiber optic cable 134, and a second equipment cabinet connection β is desirably communicatively coupled to a second radio head connection β by the second fiber optic cable 136. In some circumstances, however, the first and second fiber optic cables 134, 136 may be cross-connected as illustrated in the left-hand side of FIG. 2. As illustrated in FIG. 2, the first fiber optic cable 134 undesirably cross-connects the first equipment cabinet connection α to the second radio head connection β, and the second fiber optic cable 136 undesirably cross-connects the second equipment cabinet connection β to the first radio head connection α. In this cross-connected configuration, the associated cell of the cell site 108 may provide decreased radio performance and thereby function sub-optimally.

As illustrated in the right-hand side of FIG. 2, the cross-connection condition has been corrected so that the first fiber optic cable 134 connects the first equipment cabinet connection α to the first radio head connection α, and the second fiber optic cable 136 connects the second equipment cabinet connection β to the second radio head connection β. Correcting such a cross-connection condition is easily achieved by disconnecting the fiber optic cables 134, 136 near the equipment cabinet 130 and swapping their connections. A field technician at the cell site 108 can easily perform this action in just a few minutes. In the past, however, the cross-connection condition was not directly indicated by conventional cell equipment alarms produced by the OSSs 104. Often such an undesirable cross-connection condition would exist at a cell site 108, a field technician would visit the cell site 108 to perform maintenance related to other equipment or other alarm conditions, but the opportunity to correct the cross-connection condition was lost because the undesirable cross-connection condition was not recognized timely.

The cell site diagnosis and maintenance application 113 is configured to automatically determine if such a cross-connection condition exists. If NOC personnel execute the application 113 designating a specific cell site 108 and/or a specific cell of the cell site 108, the application 113 can provide an indication of whether a cross-connection condition exists. In that case, the NOC personnel might instruct a field technician already at the cell site 108 to correct the cross-connection condition before leaving the cell site 108. Alternatively, the application 113 may trigger automatically when the cell site 108 or a specific cell of the cell site 108 is designated to be in a maintenance mode of operation (e.g., a field technician is at the cell site 108 and performing maintenance on the cell site 108). If the automatically triggered application 113 determines that a cross-connection condition exists at the cell site 108, the application 113 may automatically message to the field technician to notify of the cross-connection condition and to instruct the field technician to correct the cross-connection condition before leaving the cell site 108.

In an embodiment, the cell site diagnosis and maintenance application 113 connects to an OSS 104 associated with the cell site 108 that is suspected of having a cross-connection condition. The application 113 initiates a secure shell (SSH) session via the connected OSS 104 to the cell and/or cell site 108. Via the SSH session, the application 113 reads configuration information from the cell and/or cell site 108. The configuration information includes an IP address in a text file. The application 113 parses the text file to determine the IP address. The application 113 initiates a second SSH session (a new SSH session within the first SSH session) to execute a command and to access information from the cell and/or cell site 108 to determine if the sector under scrutiny is an α-sector (alpha-sector), a β-sector (beta-sector), or a γ-sector (gamma-sector) of the radio head 132 and also to determine an IP address and a port identity associated with the sector under scrutiny. The obtained information allows the application 113 to associate the given cell and/or cell site 108 to a connection scenario, for example a connection scenario associated to the fiber optic cables 134, 136 and the connections of the equipment cabinet 130 and the radio head 132. In an embodiment, determining the connection scenario comprises determining if the cell comprises an ABIO type baseband processor, an ABIL type baseband processor, an ASIL type baseband processor, or an ABIC type baseband processor. In an embodiment, the method 230 further comprises determining an antenna element position associated with the fiber optic configuration as one of an alpha antenna element, a beta antenna element, and a gamma antenna element.

Based on the connection scenario—or just scenario for short—the application 113 compares the actual connection information already obtained based on the inventory to a known good connection configuration looked up by the application 113 based on the identified scenario.

If the actual connection configuration of the cell and/or cell site 108 matches the known good connection configuration, the application 113 returns a positive result. If the actual connection configuration of the cell and/or cell site 108 does not match the known good connection configuration, the application 113 returns a negative result. In an embodiment, the cell site diagnosis and maintenance application 113 may be invoked from a graphical user interface (GUI) of the NOC dashboard 116, and in this case the positive or negative result is returned to the NOC dashboard 116 in the GUI. Alternatively, as mentioned above, the result of the analysis can automatically trigger notification being sent to a field technician at the cell site 108 or on route to the cell site 108 to correct the cross-connection condition.

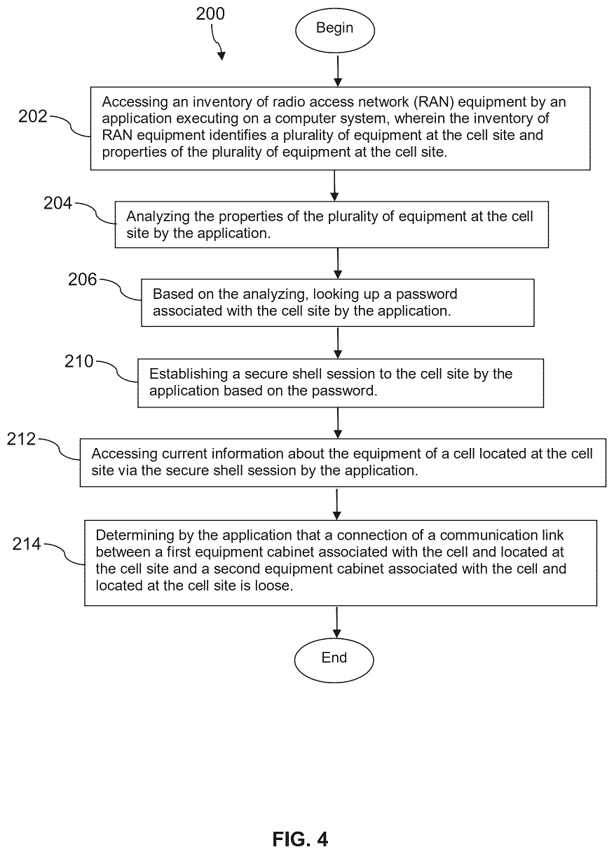

Turning now to FIG. 3, further details of a cell site 108 are described. In an embodiment, cell site equipment may comprise a first equipment cabinet A 140 and a second equipment cabinet B 142. For example, a given cell or a plurality of cells of the cell site 108 may be supported by equipment disposed in the first equipment cabinet A 140 and the second equipment cabinet B 142 disposed in a building on the ground at the cell site 108. For the cell or cells to function properly, a communication cable 144 is desirably provided between the equipment cabinets 140, 142. In an embodiment, a first connector 146 of the communication cable 144 attaches or connects to the first equipment cabinet A 140 and a second connector 148 of the communication cable 144 attaches or connects to the second equipment cabinet B 142. Under some circumstances, the first connector 146 can become loosely connected to the first equipment cabinet A 140 and cause degraded or interrupted service. Under some circumstances, the second connector 148 can become loosely connected to the second equipment cabinet B 142 and cause degraded or interrupted service.

The cell site diagnosis and maintenance application 113 can test the cell and/or cell site 108 to determine if the loose connector condition exists and which of the first connector 146 or the second connector 148 is loose. The application 113 first collects contextual information, for example an identity of a user invoking the test and information about the cell and/or cell site 108 that is the subject of the test. The application 113 first validates that the subject user has authorization to execute the test. The application 113 may associate the subject user to a privilege group and may determine if the privilege group is authorized to execute the test. If the user has authorization to execute the test, the application 113 looks up security credentials and then uses the looked-up credentials to initiate an SSH session with the OSS 104 that associates to the cell and/or cell site 108.

A custom command executes a script at the subject cell and/or cell site 108 that determines if a loose connection exists. In an embodiment, the determination may be whether the communication link between equipment cabinet A 140 and equipment cabinet B 142 is operable or is inoperable (e.g., heartbeat messages are not successfully being exchanged between equipment cabinets 140, 142). Thus, if the communication link is deemed inoperable, it is assumed that this condition is caused by a loose connection. Alternatively, a loose connection condition may be inferred to exist based on a specific pattern of alarms at the cell and/or cell site 108. After this script returns a result, the result may be presented to a user by the NOC dashboard 116. The user may then instruct a field technician at the cell site 108 to check and tighten the connections 146, 148. Alternatively, the test may be automatically triggered on the event of a field technician visiting the cell site 108. If the test determines that a loose connection condition exists, the cell site diagnosis and maintenance application 113 may send a notification or email to the field technician to tighten the connections 146, 148. It is understood that the task of tightening the connections 146, 148 may involve the field technician visually inspecting one or both of the connections 146, 148, identifying one of these connections 146, 148 to be loose, and tightening only the connection 146, 148 that is loose but not overtightening the already tight other connection 146, 148. On the other hand, if both connections 146, 148 are loose, the field technician would tighten both connections 146, 148.

It the test of the communication link between the first equipment cabinet A 140 and the second equipment cabinet B 142 does not indicate a loose connection, this negative test result may provide help in diagnosing a different root cause of alarms at the cell site 108. Thus, this test result may be provided to other diagnostic instructions of the cell site diagnosis and maintenance application 113 and/or to diagnostic routines executing at the NOC dashboard 116.

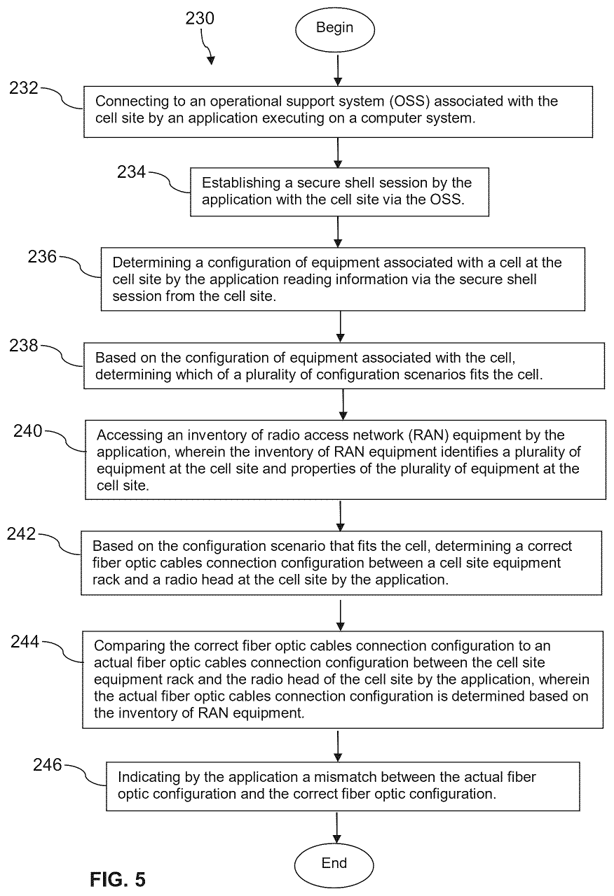

Turning now to FIG. 4, a method 200 is described. In an embodiment, the method 200 is a method of maintaining a cell site. In an embodiment, the cell site is configured to provide wireless communication links to user devices according to a 6G, a 5G, a long-term evolution (LTE), a code division multiple access (CDMA), a universal mobile communication system (UMTS), or a global system for mobile communication (GSM) telecommunication protocol. At block 202, the method 200 comprises accessing an inventory of radio access network (RAN) equipment by an application executing on a computer system, wherein the inventory of RAN equipment identifies a plurality of equipment at the cell site and properties of the plurality of equipment at the cell site. In an embodiment, the inventory of RAN equipment comprises location data describing locations of a plurality of cell sites. In an embodiment, the inventory of RAN equipment identifies radio equipment at each of a plurality of cell sites, identifies configurations of the radio equipment at each of the cell sites, identifies antenna elements and antenna sectors at each of the cell sites, identifies power equipment at each of the cell sites, identifies circuit cards at each of the cell sites, and identifies location of circuit cards within equipment cabinets at each of the cell sites. In an embodiment, the application is triggered to execute by a network operation center (NOC) worker selecting a command in a user interface of the NOC. Alternatively, the application may be triggered by placing the cell and/or cell site in a maintenance mode of operation or by scheduling the cell and/or cell site for maintenance.

At block 204, the method 200 comprises analyzing the properties of the plurality of equipment at the cell site by the application. At block 206, the method 200 comprises, based on the analyzing, looking up a password associated with the cell site by the application.

At block 210, the method 200 comprises establishing a secure shell session to the cell site by the application based on the password. At block 212, the method 200 comprises accessing current information about the equipment of a cell located at the cell site via the secure shell session by the application.

At block 214, the method 200 comprises determining by the application that a connection of a communication link between a first equipment cabinet associated with the cell and located at the cell site and a second equipment cabinet associated with the cell and located at the cell site is loose. In an embodiment, the method 200 further comprises presenting the determination that the connection of the communication link at the cell site is loose in the user interface of the NOC. In an embodiment, the presentation in the user interface of the NOC can include indicating which ports are cross-connected and therefore indicating the correct port the fiber-optic connection should be connected to. In an embodiment, the method 200 further comprises sending out a notification to a field technician to tighten the connection of the communication link between the first equipment cabinet and the second equipment cabinet by the application.

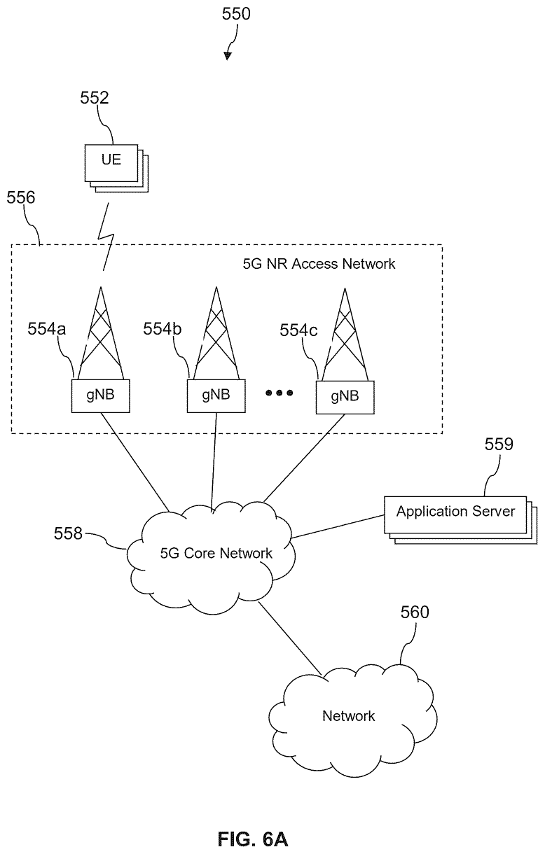

Turning now to FIG. 5, a method 230 is described. In an embodiment, the method 230 is a method of maintaining a cell site. At block 232, the method 230 comprises connecting to an operational support system (OSS) associated with the cell site by an application executing on a computer system. In an embodiment, the application is triggered to execute by a network operation center (NOC) worker selecting a command in a user interface of the NOC.

At block 234, the method 230 comprises establishing a secure shell session by the application with the cell site via the OSS. At block 236, the method 230 comprises determining a configuration of equipment associated with a cell at the cell site by the application reading information via the secure shell session from the cell site. In an embodiment, determining the configuration of equipment comprises determining if the cell comprises an ABIO type baseband processor, an ABIL type baseband processor, an ASIL type baseband processor, or an ABIC type baseband processor. In an embodiment, the method 230 further comprises determining an antenna element position associated with the fiber optic configuration as one of an alpha antenna element, a beta antenna element, and a gamma antenna element.

At block 238, the method 230 comprises, based on the configuration of equipment associated with the cell, determining which of a plurality of configuration scenarios fits the cell. At block 240, the method 230 comprises accessing an inventory of radio access network (RAN) equipment by the application, wherein the inventory of RAN equipment identifies a plurality of equipment at the cell site and properties of the plurality of equipment at the cell site. In an embodiment, the inventory of RAN equipment identifies radio equipment at each of a plurality of cell sites, identifies configurations of the radio equipment at each of the cell sites, identifies antenna elements and antenna sectors at each of the cell sites, identifies power equipment at each of the cell sites, identifies circuit cards at each of the cell sites, and identifies location of circuit cards within equipment cabinets at each of the cell sites.

At block 242, the method 230 comprises, based on the configuration scenario that fits the cell, determining a correct fiber optic cables connection configuration between a cell site equipment rack and a radio head at the cell site by the application. At block 244, the method 230 comprises comparing the correct fiber optic cables connection configuration to an actual fiber optic cables connection configuration between the cell site equipment rack and the radio head of the cell site by the application, wherein the actual fiber optic cables connection configuration is determined based on the inventory of RAN equipment.

At block 246, the method 230 comprises indicating by the application a mismatch between the actual fiber optic configuration and the correct fiber optic configuration. In an embodiment, indicating a mismatch between the actual fiber optic configuration and the correct fiber optic configuration comprises presenting information about the mismatch in the user interface of the NOC. In an embodiment, the method 230 further comprises sending out a notification to a field technician to swap the connections of the fiber optic cables at the cell site equipment rack.

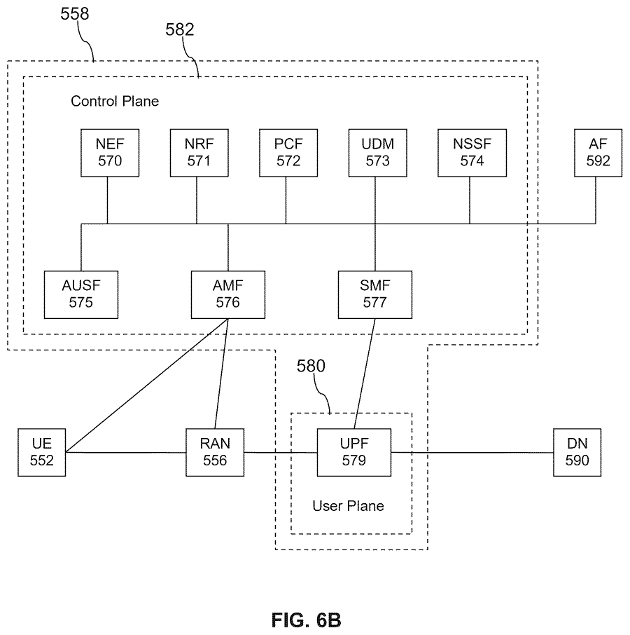

Turning now to FIG. 6A, an exemplary communication system 550 is described. Typically the communication system 550 includes a number of access nodes 554 that are configured to provide coverage in which UEs 552 such as cell phones, tablet computers, machine-type-communication devices, tracking devices, embedded wireless modules, and/or other wirelessly equipped communication devices (whether or not user operated), can operate. The access nodes 554 may be said to establish an access network 556. The access network 556 may be referred to as a radio access network (RAN) in some contexts. In a 5G technology generation an access node 554 may be referred to as a next Generation Node B (gNB). In 4G technology (e.g., long-term evolution (LTE) technology) an access node 554 may be referred to as an evolved Node B (eNB). In 3G technology (e.g., code division multiple access (CDMA) and global system for mobile communication (GSM)) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”—such as Long-Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node 554 could allocate as needed to carry data between the access node 554 and served UEs 552.

In addition, certain resource elements on the example air interface could be reserved for special purposes. For instance, on the downlink, certain resource elements could be reserved to carry synchronization signals that Ues 552 could detect as an indication of the presence of coverage and to establish frame timing, other resource elements could be reserved to carry a reference signal that Ues 552 could measure in order to determine coverage strength, and still other resource elements could be reserved to carry other control signaling such as PRB-scheduling directives and acknowledgement messaging from the access node 554 to served Ues 552. And on the uplink, certain resource elements could be reserved to carry random access signaling from Ues 552 to the access node 554, and other resource elements could be reserved to carry other control signaling such as PRB-scheduling requests and acknowledgement signaling from Ues 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 6B, further details of the core network 558 are described. In an embodiment, the core network 558 is a 5G core network. 5G core network technology is based on a service-based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 6A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow-based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be executed on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

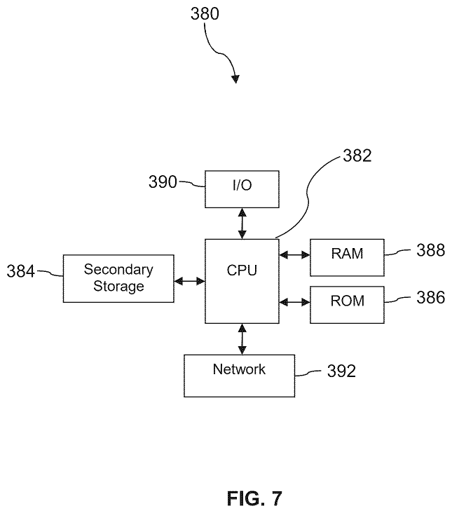

FIG. 7 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of maintaining a cell site, comprising:
accessing an inventory of radio access network (RAN) equipment by an application executing on a computer system, wherein the inventory of RAN equipment identifies a plurality of equipment at the cell site and properties of the plurality of equipment at the cell site;
analyzing the properties of the plurality of equipment at the cell site by the application;
based on the analyzing, looking up a password associated with the cell site by the application;
establishing a secure shell session to the cell site by the application based on the password;
accessing current information about the equipment of a cell located at the cell site via the secure shell session by the application; and
determining by the application that a connection of a communication link between a first equipment cabinet associated with the cell and located at the cell site and a second equipment cabinet associated with the cell and located at the cell site is loose.

2. The method of claim 1, wherein the inventory of RAN equipment comprises location data describing locations of a plurality of cell sites.

3. The method of claim 1, wherein the inventory of RAN equipment identifies radio equipment at each of a plurality of cell sites, identifies configurations of the radio equipment at each of the cell sites, identifies antenna elements and antenna sectors at each of the cell sites, identifies power equipment at each of the cell sites, identifies circuit cards at each of the cell sites, and identifies location of circuit cards within equipment cabinets at each of the cell sites.

4. The method of claim 1, further comprising triggering the application to execute by a network operation center (NOC) worker selecting a command in a user interface of the NOC.

5. The method of claim 4, presenting the determination that the connection of the communication link at the cell site is loose in the user interface of the NOC.

6. The method of claim 1, sending out a notification to a field technician to tighten the connection of the communication link between the first equipment cabinet and the second equipment cabinet by the application.

7. The method of claim 1, wherein the cell site is configured to provide wireless communication links to user devices according to a 6G, a 5G, a long-term evolution (LTE), a code division multiple access (CDMA), a universal mobile communication system (UMTS), or a global system for mobile communication (GSM) telecommunication protocol.

8. A method of maintaining a cell site, comprising:
connecting to an operational support system (OSS) associated with the cell site by an application executing on a computer system;
establishing a secure shell session by the application with the cell site via the OSS;
determining a configuration of equipment associated with a cell at the cell site by the application reading information via the secure shell session from the cell site;
based on the configuration of equipment associated with the cell, determining which of a plurality of configuration scenarios fits the cell;
accessing an inventory of radio access network (RAN) equipment by the application, wherein the inventory of RAN equipment identifies a plurality of equipment at the cell site and properties of the plurality of equipment at the cell site;
based on the configuration scenario that fits the cell, determining a correct fiber optic cables connection configuration between a cell site equipment rack and a radio head at the cell site by the application;
comparing the correct fiber optic cables connection configuration to an actual fiber optic cables connection configuration between the cell site equipment rack and the radio head of the cell site by the application, wherein the actual fiber optic cables connection configuration is determined based on the inventory of RAN equipment; and
indicating by the application a mismatch between the actual fiber optic configuration and the correct fiber optic configuration.

9. The method of claim 8, wherein determining the configuration of equipment comprises determining if the cell comprises an ABIO type baseband processor, an ABIL type baseband processor, an ASIL type baseband processor, or an ABIC type baseband processor.

10. The method of claim 8, further comprising determining an antenna element position associated with the fiber optic configuration as one of an alpha antenna element, a beta antenna element, and a gamma antenna element.

11. The method of claim 8, wherein the inventory of RAN equipment identifies radio equipment at each of a plurality of cell sites, identifies configurations of the radio equipment at each of the cell sites, identifies antenna elements and antenna sectors at each of the cell sites, identifies power equipment at each of the cell sites, identifies circuit cards at each of the cell sites, and identifies location of circuit cards within equipment cabinets at each of the cell sites.

12. The method of claim 8, further comprising triggering the application to execute by a network operation center (NOC) worker selecting a command in a user interface of the NOC.

13. The method of claim 12, wherein indicating a mismatch between the actual fiber optic configuration and the correct fiber optic configuration comprises presenting information about the mismatch in the user interface of the NOC.

14. The method of claim 8, sending out a notification to a field technician to swap the connections of the fiber optic cables at the cell site equipment rack.

15. A cell site maintenance system, comprising:
an at least one processor;
a non-transitory memory, and
an application stored in the non-transitory memory that, when executed by the at least one processor
receives an activation input from a user of a network operation center (NOC),
accesses inventory of radio access network (RAN) equipment, wherein the inventory or RAN equipment identifies a plurality of equipment at each of a plurality of cell sites,
establishes a secure shell session to a cell site,
accesses information about equipment at the cell site,
based on accessing the inventory and on accessing information about equipment at the cell site, tests if a connection of a communication link between a first equipment cabinet and a second equipment cabinet at the cell site is loose,
based on accessing the inventory and on accessing information about equipment at the cell site, tests if a fiber optic link between an equipment rack at the cell site and a radio head of the cell site is cross-connected,
if the connection between the connection is loose, notifies a technician located at the cell site to tighten the connection, and
if the fiber optic link is cross-connected, notifies a technician located at the cell site to reconnect the fiber optic link.

16. The method of claim 15, wherein the inventory of RAN equipment identifies radio equipment at each of a plurality of cell sites, identifies configurations of the radio equipment at each of the cell sites, identifies antenna elements and antenna sectors at each of the cell sites, identifies power equipment at each of the cell sites, identifies circuit cards at each of the cell sites, and identifies location of circuit cards within equipment cabinets at each of the cell sites.

17. The method of claim 15, wherein the activation input identifies the cell site.

18. The method of claim 15, wherein testing if the fiber optic link is cross-connected comprises determining if the cell comprises an ABIO type baseband processor, an ABIL type baseband processor, an ASIL type baseband processor, or an ABIC type baseband processor.

19. The method of claim 15, wherein testing if the fiber optic link is cross-connected comprises determining an antenna element position associated with the fiber optic configuration as one of an alpha antenna element, a beta antenna element, and a gamma antenna element.

20. The method of claim 15, wherein the cell site is configured to provide wireless communication links to user devices according to a 6G, a 5G, a long-term evolution (LTE), a code division multiple access (CDMA), a universal mobile communication system (UMTS), or a global system for mobile communication (GSM) telecommunication protocol.
